(19) United States
(12) Patent Application Publication
(10) Pub. No.: US 2007/0239571 A1
(43) Pub. Date: Oct. 11, 2007

(54) Providing fixed income from investment assets

(75) Inventor: Joseph G. Michaletz, North Mankato, MN (US)

Correspondence Address: MERCHANT & GOULD PC, P.O. BOX 2903, MINNEAPOLIS, MN, 55402-0903, US

(73) Assignee: Discipline Advisors, Inc.

(21) Appl. No.: 11/385,318

(22) Filed: Mar. 20, 2006

(51) Int. Cl. G06Q 40/00

(52) U.S. Cl. 705/35

(57) ABSTRACT

A method and device for providing a fixed income from a range of assets is disclosed. In one aspect, the assets are divided into a first group associated with relatively low liquidity risks and a second group associated with liquidity risks higher than that of the first group such that the second group does not need to be liquidated sooner than a predetermined length, such as five years. An asset in the second group is sold only when that asset has gained in value by a predetermined amount, such as 20%, over the principle within a predetermined period of time, such as a year. In another aspect, investments in the second group are made in at least two asset classes that have historically exhibited a strong inverse price correlation with each other. The holdings in the two inversely related asset classes are rebalanced when the performance of one class exceeds the performance of the other class by a predetermined amount, such as 80% of the average of the maxima or minima in historical performance difference.

### BACKGROUND

Volatility in markets for investment instruments, such as stocks and bonds, presents both risks and opportunities for investors. The timing of buying and selling investment instruments poses a constant challenge to investors, as human traits, such as greed and fear, often interfere with rational analysis of the market in the face of the volatility.

For example, whereas the equity markets tend to provide positive, or at least more predictable, returns when viewed with a time horizon of several years or longer, the short-term returns are much more unpredictable. Yet, most investors are motivated to buy or sell by the perceived short-term prospect of the markets and thus typically hold any given equity for a short period of time, such as less than two years. This often results in, for example, irrational buying of overpriced investment instruments on the price upswing because the investors are afraid of “missing the boat”; likewise, investors often participate in panic selling at undue losses, when the price of an investment instrument falls, for fear of being “left holding the bag”. Such herd mentality and the market prices often form vicious cycles, resulting in large losses for many investors.

Large financial institutions are often ill equipped to resist or escape the irrational forces of the herd mentality. For example, it typically would take several months for a large mutual fund to divest its largest holdings without significantly negatively impacting the price of the stock. But in a panic-selling situation, where a large number of shareholders demand immediate redemption of their shares, a fund manager may well be forced to sell the stocks in a much shorter period of time than is adequate to avoid negatively impacting the stock price.

Providing fixed income from a range of assets presents an additional level of complexity in the asset management tasks. Because a set amount of funds must be withdrawn from the investment assets periodically, certain assets must be sold periodically. Selling volatile assets such as stocks prematurely to cover the fund withdrawal is undesirable, as more shares must be sold when the per-share value is down, thereby more severely impact the position in the asset.

Thus, a systematic, rational system of managing investment portfolios to provide fixed income is needed.

### SUMMARY

In general, this patent relates to providing a fixed income from a range of assets. More particularly, this patent relates to allocating the assets into a first group associated with relatively low liquidity risks and a second group associated with liquidity risks higher than that of the first group such that the second group does not need to be liquidated in a time frame shorter than a predetermined length, such as five (5) years. The patent further relates to liquidating a portion of the second group only when that portion has gained in value by a predetermined about, such as 20%, within a predetermined period of time, such as a year. The patent further relates to investing the assets in the second group in at least two asset classes that have historically exhibited an inverse price correlation with each other, and rebalancing the holding in the two asset classes when the performance of one class exceeds the performance of the other class by a predetermined amount, such as 80% of the average of the maxima or minima in historical performance difference.

In one aspect, a method of providing income from assets of a total value, the amount of the income bearing a predetermined relationship to the total value, the method comprising dividing the assets into two categories, the first category comprising an asset associated with a level liquidity risks, the second category comprising an asset associated with a higher level of liquidity risks than the asset in the first category. The method further comprises distributing income only from the first category and liquidating the asset from the second category only when the asset in the second category has gained a predetermined amount. The method may further comprise including two classes of assets in the second category, the two classes of assets that have historically exhibited an inverse price correlation with each other, and rebalancing the holding in the two asset classes when the performance of one class exceeds the performance of the other class by a predetermined amount.

In another aspect, a computer program product comprises a computer-readable medium having stored thereon a computer program for tracking the values of two categories of assets, the first category comprising an asset associated with a level of liquidity risks, the second category comprising an asset having associated with a level of liquidity risks that is higher than that of the asset in the first category. The program further provides an indication when the value of the asset in the second category has increased by a predetermined amount within a predetermined period of time. The program may further track two classes of assets in the second category that have historically exhibited an inverse price correlation with each other, and providing an indication when the performance of one class exceeds the performance of the other class by a predetermined amount.

### BRIEF DESCRIPTION OF THE DRAWINGS

FIG. 1 shows the annual returns of the S&P 500 index over a 33-year period.

FIG. 2 shows the rolling five-year averages of the annual returns of the S&P 500 index over the same 33-year period as in FIG. 1.

FIG. 3 shows the asset allocation in an illustrative embodiment of the invention.

FIG. 4 outlines a method of asset management in an illustrative embodiment of the invention.

FIG. 5 shows a computer system for asset management in an illustrative embodiment of the invention.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Additionally, the embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

The logical operations of the various embodiments can be implemented (1) as a sequence of computer implemented operations running on a computing system and/or (2) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

The embodiments of the invention take into account one or more of the following observations of the investment markets. First, different asset types have different degrees of volatility and corresponding levels of liquidity risks. For example, short-term assets, such as money market funds, are highly liquid and the least volatile and thus associated with the lowest levels of liquidity risks; medium-term assets, such as corporate bonds, have intermediate liquidity and volatility and are associated with intermediate levels of liquidity risks; the long-term assets, such as equity (stocks), are the least liquid and most volatile and thus associated with the highest levels of liquidity risks. It is therefore advantageous to withdraw funds to provide income from assets of relatively short-term and high liquidity.

The volatility, or liquidity risk, of an asset can be described in quantitative terms commonly understood in the art. For example, “beta” is a commonly used measure of volatility of an asset as compared to a benchmark, such as a market index. The benchmark has a beta of 1.0. An asset with a beta of greater than 1.0 is more volatile than the benchmark; an asset with a beta of less than 1.0 is less volatile than the benchmark. Thus, the respective beta values of two assets can be used numerically to compare the liquidity risks of two assets if the beta values are referenced to the same benchmark, or, if they are referenced to different benchmarks, the relative volatility between the benchmarks is known.

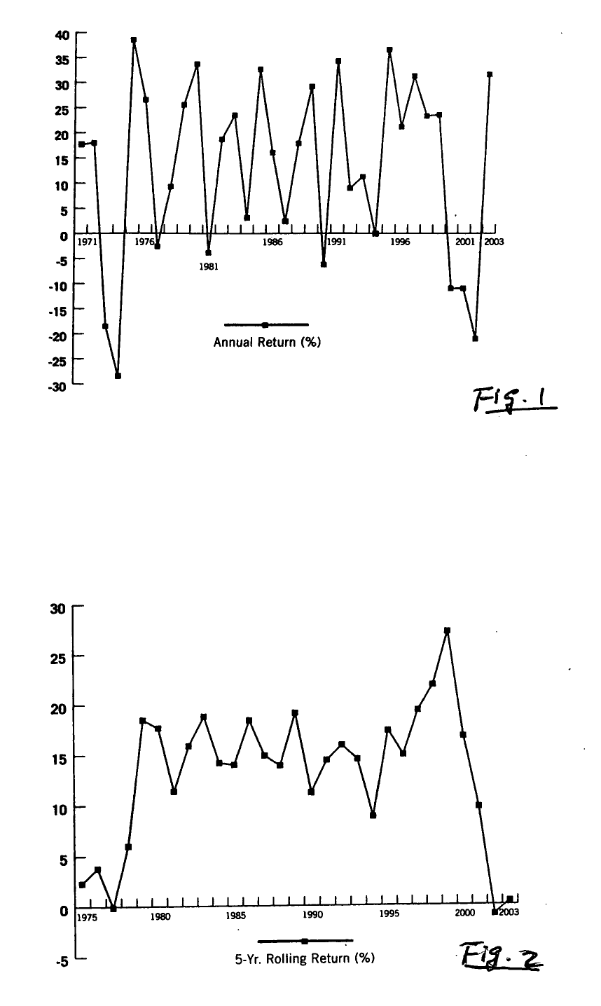

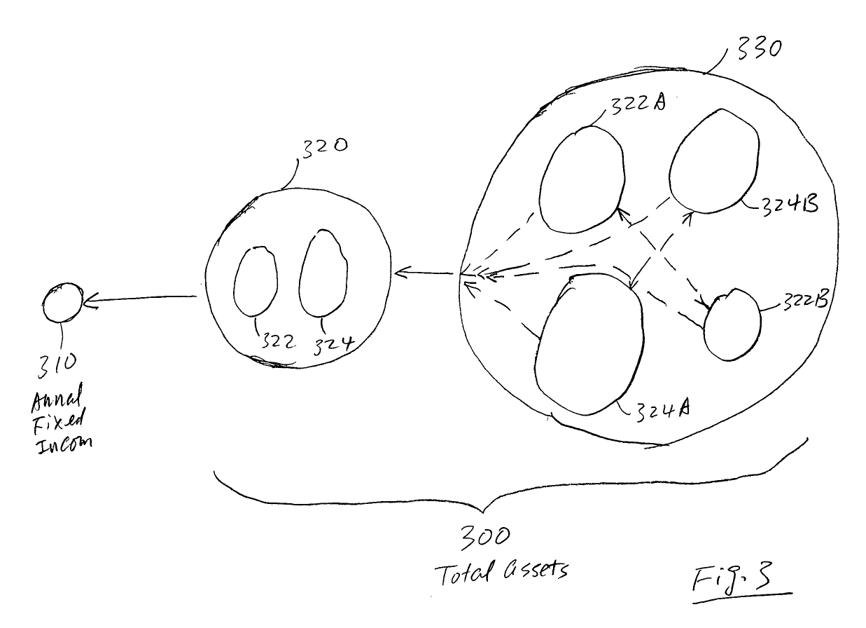

Second, even for high-volatility assets, the performance averaged over a sufficient length of time tends to fluctuate much less than the short-term performance. For example, as shown in FIG. 1, annual returns for the Standard-and-Poor (S&P) 500 companies fluctuated widely during the period between 1970 and 2003, with negative returns in ten out of thirty three years. In fact, an investor owning S&P 500 stocks with one-year holding periods would have lost money about 37% of the time between 1930 and 2004. In contrast, as shown in FIG. 2, holding equity in the S&P 500 companies for five-year periods during the same period would have resulted losses many fewer times, about 4% of the time for the period between 1930 and 2004. It is therefore advantageous to have holding periods of a significant minimum length, for example, five years, for equity.

Third, certain classes of assets exhibit strong inverse correlation, i.e., the improved performance in asset class is matched by the diminished performance in another asset class. For example, the performance of large-capital stocks, such as those in the Standard-and-Poor 500 index, tends to fluctuate in inverse correlation to the performance of small-capital stocks, such as those in the Russell 2000 index. Other asset class pairs with inverse correlations with each other may be identified from various compilations of market performance records. For example, the asset classes of large-cap value and small-cap growth are strongly inversely correlated to each other. Similarly, the asset classes of small-cap value and large-cap growth are strongly inversely correlated to each other. See also, for example, the Callan Periodic Table of Investment Returns, published by the Callan Associates Inc., San Francisco. Simultaneous investment in inversely correlated equities thus reduces volatility. It is therefore advantageous to invest in pairs of strongly inversely correlated asset classes and rebalance the equity portfolio when one asset class has significantly outperformed the asset class with which the former has a strong inverse correlation to. In one illustrative embodiment, for example, with investment in both a Russell 2000 Value index and the S&P/Barra 500 growth index with a starting asset allocation, trigger points for rebalance in one illustrative embodiment of the invention is set at 80% of the averages of the historic maxima and minima, respectively, of the performance difference between the two asset classes. That is, when the S&P/Barra 500 outperforms the Russell 2000 Value by an amount reaching 80% of the historical average of the maximum difference between the two indices, some money is taken out of S&P/Barra 500 and put in the Russell 2000 Value to achieve the starting allocation between the two funds.

The degree of correlation can be characterized in a variety of ways. A common quantity used in statistics to measure correlation between two sets of numbers (e.g., historical annual returns for two asset classes) is the correlation coefficient, with a correlation coefficient of 1 being indicative of perfect correlation, −1 being indicative of perfect inverse correlation, and 0 being indicative of complete random relationship. For the purpose of the present application, two asset classes with a correlation coefficient of between −0.7 and −1, inclusive, are considered strongly inversely correlated.

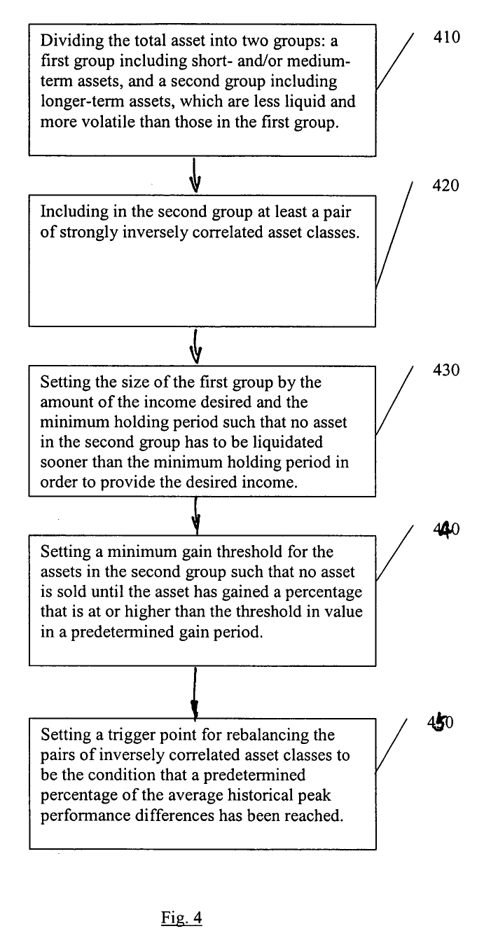

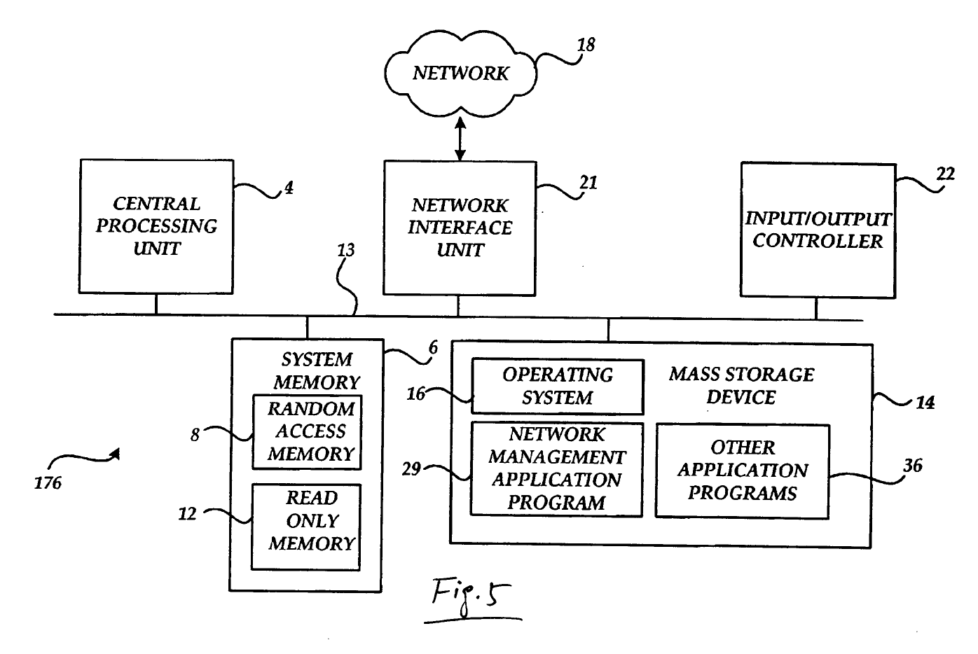

Referring now to FIGS. 3 and 4, in one illustrative embodiment, a method 400 of providing income 310 from the total asset 300 includes dividing (410) the total asset into two groups: a first group 320 including short- (322) and/or medium-term assets (324), and a second group 330 including longer-term assets, which are less liquid and more volatile than those in the first group 320. The assets in the second group 330 are chosen (420) to include pairs of strongly inversely correlated asset classes. For example, asset classes 322A and 322B have a strong inverse correlation to each other, and so do asset classes 324A and 324B. The income 310 is taken periodically (430) from the first group only. No asset in the second group 330 is sold until it has been held for a predetermined minimum holding period (e.g., five years) unless it has achieved the predetermined percentage in a predetermined gain period (e.g., 20% per year).

The size of the first group 320 is determined (430) by the amount of the income 310 desired and the minimum holding period such that no asset in the second group 330 has to be liquidated sooner than the minimum holding period in order to provide the desired income 310. For example, if the desired income is 6% of the total asset (e.g., $60,000 per year out of a total asset of $1,000,000), and the minimum holding period is five years, then 30% (5×6%, or $300,000) of the total asset 300 is allocated to the first group 320, and the remainder (70%) is allocated to the second group 330. This way, income 310 can be provided entirely from the first group for five years without having to sell any asset in the second group.

Furthermore, a minimum gain threshold is set (440) for the assets in the second group 330. An asset 322A, 322B, 324A or 324B is not sold until the asset has gained a percentage that is at or higher than the threshold (e.g., 20%) in value (using the asset value after the last sale of shares as basis) in a predetermined gain period (e.g., in a calendar year). Each asset is sold at most once in the gain period. The proceeds of the sales are moved into the first group or used to rebalance the asset class with the asset class having the inverse correlation. More specifically, when an asset has gained the predetermined percentage over the starting principle, all or part of the gain is realized, as necessary, to restore the first group to its starting principle ($300,000 in the example above), or to rebalance the asset classes in the second group 330. No part of the principle is sold.

In addition, a trigger point is set (450) for rebalancing the pairs of inversely correlated asset classes 322A/322B and 324A/324B. For example, if the asset class 322A has historically outperformed the asset class 322B by an average of 25 percentage points at the peaks of discrepancy between the performances of the two classes, a trigger point may be set at 20 percentage points, or 80%, of the average historical peak discrepancies. That is, after the first group has been replenished, as necessary, as discussed above, when the asset class 322A has outperformed the asset class 322B by 20 percentage points, asset classes 322A and 322B are rebalanced to achieve the starting allocation between the two by realizing all or part of the remaining gain in the asset class 322A, as necessary.

Thus, a fixed income can be provided without having to liquidate any equities sooner than five years, thereby reducing the liquidity risk of the asset group 330. This, combined with the predetermined trigger point for selling an asset, serves to eliminate any transactions driven by human emotions. In addition, simultaneous investments in strongly inversely correlated asset classes, with rebalancing at predetermined trigger points, further reducing the impact of market volatility.

The disciplined approach described above enables an investor to sell the least number of shares of volatile assets to provide fixed income. This helps preserve the maximum number of shares for greater growth potential. As demonstrated by the examples below, while the order of annual earnings does not affect the end value of the investment if the assets are left to accumulate (Table I), the order does matter significantly when funds must be withdrawn periodically from the investment to provide income (Table II). In particular, significant declines in prices early on in the investment cycle forces large numbers of shares to be sold to cover income.

TABLE I
Asset Values for Accumulation for
Different Orders of Growth Rates

| | |
|---|---|
| Sequence 1 | Sequence 2 |

| Year | Return | EOY Value | Return | EOY Value |
|---|---|---|---|---|
| 0 | | $1,000,000 | | $1,000,000 |
| 1 | 23% | 1,230,000 | −8% | 920,000 |
| 2 | 11% | 1,365,300 | 18% | 1,085,600 |
| 3 | −2% | 1,337,994 | −2% | 1,063,888 |
| 4 | 18% | 1,578,833 | 11% | 1,180,916 |
| 5 | −8% | 1,452,526 | 23% | 1,452,526 |
| Average | 7.75% | | 7.75% | |

TABLE II
Asset Values for Periodic Withdrawals for
Different Orders of Growth Rates

| | |
|---|---|
| Sequence 1 | Sequence 2 |

| Year | Return | EOY Value | Return | EOY Value |
|---|---|---|---|---|
| 0 | | $1,000,000 | | $1,000,000 |
| 1 | 23% | 1,107,000 | −8% | 828,000 |
| 2 | 11% | 1,117,770 | 18% | 859,040 |
| 3 | −2% | 997,415 | −2% | 743,859 |
| 4 | 18% | 1,058,949 | 11% | 714,683 |
| 5 | −8% | 882,233 | 23% | 756,061 |
| Average | 8.92% | | 6.33% | |

As another example, the five-year performance of a portfolio of 10,000 shares in an S&P 500 index fund with a starting share price of $10 is shown in Table III. The portfolio is to provide $6,000 of income per year in this example.

TABLE III
Portfolio Performance-Income from Equities
(Portfolio: 100% Equities)

| | | | # of | | |
|---|---|---|---|---|---|
| | | | Shares | | |
| | | | Sold for | | Total Value |
| End of | Growth | Share | $6000 of | # of Shares | of Portfolio |
| Year | Rate (%) | Price ($) | Income | Remaining | ($) |
| 2000 | — | 10.00 | — | 10000 | 100000 |
| 2001 | −11.89 | 8.81 | 681 | 9319 | 82100 |
| 2002 | −22.1 | 6.86 | 875 | 8444 | 57926 |
| 2003 | +28.68 | 8.83 | 680 | 7764 | 68556 |
| 2004 | +10.88 | 9.79 | 613 | 7151 | 70008 |
| 2005 | +4.91 | 10.27 | 584 | 6567 | 67443 |

Thus, providing a fixed income of $6,000 from an S&P 500 index fund would have left $67,443 at the end of the five-year period. In contrast, as shown below in Table IV, using the inventive method described above, i.e., providing fixed income from $30,000 invested in short-term assets (for example, Lehman Brothers Aggregate Bond Index) and investing $70,000 in an S&P 500 index fund, would have resulted in a much better performance: Because the S&P 500 index fund never reached 20% above the initial principle, it would have never been sold. The result would have been $71,890 remaining in the equities and $7,302 remaining in the bonds, for a total of $79,192, or a 9.2% total return after five years. By comparison, for the case outlined in Table III, the total return over the same five years would have been −2.5%, with $67.443 remaining.

TABLE IV
Portfolio Performance-Income from Bonds
(Portfolio: 30% Bonds and 70% Equities)

| | | | # of | | | | | # of | | | Total |
|---|---|---|---|---|---|---|---|---|---|---|---|
| | | | Shares | | Total | | | Shares | | Total | Values of |
| End | Growth | Share | Sold for | # of | Value of | Growth | Share | Sold for | # of | Value of | Equities |
| of | Rate | Price | $6000 of | Shares | Equities | Rate | Price | $6000 of | Shares | Bonds | and |
| Year | (%) | ($) | Income | Remaining | ($) | (%) | ($) | Income | Remaining | ($) | Bonds |
| 2000 | — | 10.00 | — | 7000 | 70000 | — | 10.00 | — | 3000 | 30000 | 100000 |
| 2001 | −11.89 | 8.81 | 0 | 7000 | 61670 | 8.43 | 10.84 | 554 | 2446 | 26515 | 88185 |
| 2002 | −22.1 | 6.86 | 0 | 7000 | 48020 | 10.26 | 11.96 | 502 | 1944 | 23250 | 71270 |
| 2003 | +28.68 | 8.83 | 0 | 7000 | 61810 | 4.1 | 12.45 | 482 | 1462 | 18202 | 80012 |
| 2004 | +10.88 | 9.79 | 0 | 7000 | 68530 | 4.34 | 12.99 | 462 | 1000 | 12990 | 81520 |
| 2005 | +4.91 | 10.27 | 0 | 7000 | 71890 | 2.43 | 13.30 | 451 | 549 | 7302 | 79192 |

The method illustrated above can be implemented in various aspects by computers. In one embodiment of the invention, one or more computers can be programmed to track the total asset amount, asset allocation and asset performance. The computer can be further programmed to provide indications to the user (e.g., the portfolio manager) to alert him or her that various threshold points or trigger points discussed above have been reached. The computer can further be programmed to automatically calculate the amount of assets to buy or sell based on such factors as the need to rebalance inversely correlated asset classes. The computer, when connected to a market transaction system, can also be further programmed to execute the necessary transactions.

A wide variety of computers can be programmed to carry out the method described above. In particular, a general purpose may be used. A general purpose computer 176 typically has the components and configuration as shown in FIG. 5. The computer 176 in this case has a central processing unit (CPU) 4, system memory 6, a mass storage device 14, a network interface unit 21 and an input/output controller 22, all interconnected by a data bus 13. The system memory 6 includes random-access memory and read-only memory for storing the program being executed by the CPU 4. The mass storage device 14, such as a magnetic hard drive or optical disc drive, stores the operating system 16, network management application program 29 and other application programs 36 for loading into the system memory 6 for execution by the CPU 4. The input/output controller 22 manages input devices such as keyboard and mouse and output devices such as display monitor and sound systems. Finally, the network interface unit 21 manages the communication between the computer 176 and the network 18.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

The claims are:

1. A method of providing income from a collection of assets of a total value, the method comprising:
dividing the collection of assets into at least two groups, the first group comprising an asset having a liquidity risk level, the second category comprising an asset having a liquidity risk level higher than the liquidity risk level of the asset in the first category;
providing income exclusively from the first group; and
liquidating the asset from the second group only when the asset in the second category has gained a predetermined amount during a predetermined period.

2. The method of claim 1, further comprising
including in the second group assets from as least two asset classes;
monitoring the relative performance between the two asset classes;
obtaining a measure of the historical peak differences between the performances of the two asset classes;
setting a trigger condition as when one of the two asset classes outperforms the other by an amount bearing a predetermined relationship to the measure of the historical peak differences; and
adjusting asset allocation between the two asset classes when the trigger condition is met.

3. The method of claim 2, wherein the measure of the historical peak differences is an average of the historical peak differences.

4. The method of claim 3, wherein the trigger condition is met when one of the two asset classes outperforms the other by an amount that is at least a predetermined fraction of the average of the historical peak differences.

5. The method of claim 1, wherein dividing the collection of assets into at least two groups comprises setting the size of the first group based on the amount of income to be provided per predetermined unit period and a predetermined minimum holding period during which the assets in the second group is not to be sold unless the predetermined gain amount is reached.

6. The method of claim 5, wherein the minimum holding period is about five years.

7. The method of claim 5, wherein the size of the first group is about amount of income to be provided per predetermined
$$unit period \times \frac{minimum holding period}{unit period}$$

8. The method of claim 7, wherein the size of the first group is about the amount of income to be provided per year×5 years.

9. The method of claim 1, further comprising transferring the proceeds of liquidating the asset from the second group into the first group.

10. The method of claim 1, further comprising setting a value of the assets in the first group to be sufficient to exclusively provide a desired income for the predetermined minimum holding period.

11. The method of claim 1, wherein the predetermined amount for the gain in the asset in the second group is about 20% per year.

12. The method of claim 2, wherein including in the second group assets from as least two asset classes comprises including assets from as least two asset classes with respective historical performances mutually inversely correlated with a correlation coefficient of about −0.7 to −1.0.

13. The method of claim 4, wherein the trigger condition is met when one of the two asset classes outperforms the other by an amount that is at least 80% of the average of the historical peak differences

14. A computer program product comprising a computer-readable medium having stored thereon a computer program coded for:
tracking the values of two categories of assets, the first category comprising an asset having a liquidity risk level, the second category comprising an asset having a liquidity risk level higher than the liquidity risk level of the asset in the first category; and
providing an indication when the value of the asset in the second category has increased by a predetermined amount within a predetermined period of time.

15. The computer program product of claim 12, wherein the computer program is further coded for tracking two classes of assets in the second category that have historically exhibited an inverse price correlation with each other with a correlation coefficient of about −0.7 to about −1, and providing an indication when the performance of one class exceeds the performance of the other class by a predetermined amount.

16. The computer program product of claim 15, the program being further coded for calculating a allocation between the two classes of assets upon the performance of one class exceeding the performance of the other class by a predetermined amount.
